(19) United States
(12) Patent Application Publication
(10) Pub. No.: US 2012/0267869 A1
(43) Pub. Date: Oct. 25, 2012

(54) MODULAR DOLLY

(76) Inventor: Jon P. Hassell, Atlanta, GA (US)

(21) Appl. No.: 13/277,424

(22) Filed: Oct. 20, 2011

Related U.S. Application Data
(60) Provisional application No. 61/394,969, filed on Oct. 20, 2010.

(51) Int. Cl. B62B 3/10; B23P 11/00

(52) U.S. Cl. 280/79.11; 29/428; 29/426.2

(57) ABSTRACT

A dolly includes a platform for supporting items thereon. The platform includes a first edge having a plurality of complementary projections and recesses, such that the platform can be selectively connected to a first edge of a platform of an identical dolly. A plurality of wheels support the platform.

This application claims priority to U.S. Provisional Application Ser. No. 61/394,969, filed Oct. 20, 2010.

### BACKGROUND

A dolly typically includes a platform supported by a plurality of wheels. Some dollies are configured to support a plurality of trays, such as bakery trays, in a single stack. Some dollies are connectable via moving connectors or latches that are selectively moved from an unlocked position to a locked position.

### SUMMARY

A dolly includes a platform for supporting items thereon. The platform includes a first edge having a plurality of complementary projections and recesses, such that the platform can be selectively connected to a first edge of a platform of an identical dolly. A plurality of wheels support the platform.

According to one method of the present invention, the dolly can be connected to the identical dolly without any moving connectors or latches. The platform of the first dolly is moved toward the platform of the second dolly. One of the platforms is rotated relative to the other platform to a relative orientation in which the platforms are not parallel. The platforms are returned to a relative parallel orientation, thereby connecting the platform of the first dolly to the platform of the second dolly.

### BRIEF DESCRIPTION OF THE DRAWINGS

FIG. 1 is a perspective view of a dolly according to one embodiment of the present invention.

FIG. 2 is a top view of the dolly.

FIG. 3 is a side view of the connecting side edge of the dolly.

FIG. 4 is a front view of the connecting front edge of the dolly.

FIG. 5 is a perspective view of the dolly of FIG. 1 being connected to a second dolly.

FIG. 6 is a front view of the dollies of FIG. 5.

FIG. 7 is a side view of the dollies of FIG. 5.

FIG. 8 shows the dollies of FIG. 5 connected together.

FIG. 9 is a top view of the dollies of FIG. 8.

FIG. 10 shows the dollies of FIG. 5 with a tray stacked thereon.

FIG. 11 shows the dollies of FIG. 5 with two trays stacked thereon.

FIG. 12 shows the dollies of FIG. 5 with a tray being slid onto the trays.

FIG. 13 is a front view of the dollies and trays of FIG. 12.

FIG. 14 is an enlarged view of a portion of FIG. 13.

FIG. 15 shows the dollies of FIG. 5 connected along their front edges.

FIG. 16 is a top view of the dollies of FIG. 15.

FIG. 17 is a side view of the dollies of FIG. 15.

FIG. 18 shows the dollies of FIG. 15 with a tray stacked thereon.

FIG. 19 shows the dollies of FIG. 15 with two trays stacked thereon.

FIG. 20 shows the dollies of FIG. 15 with a tray being slid onto one of the dollies.

### DETAILED DESCRIPTION OF THE PREFERRED EMBODIMENT

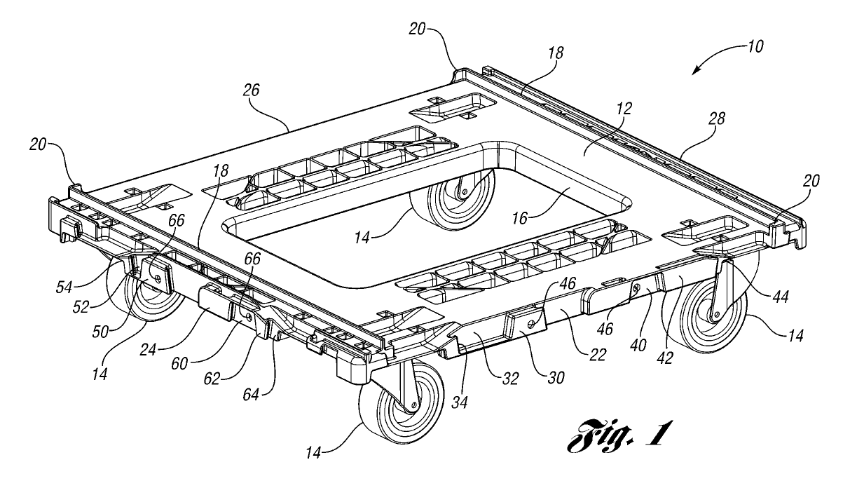

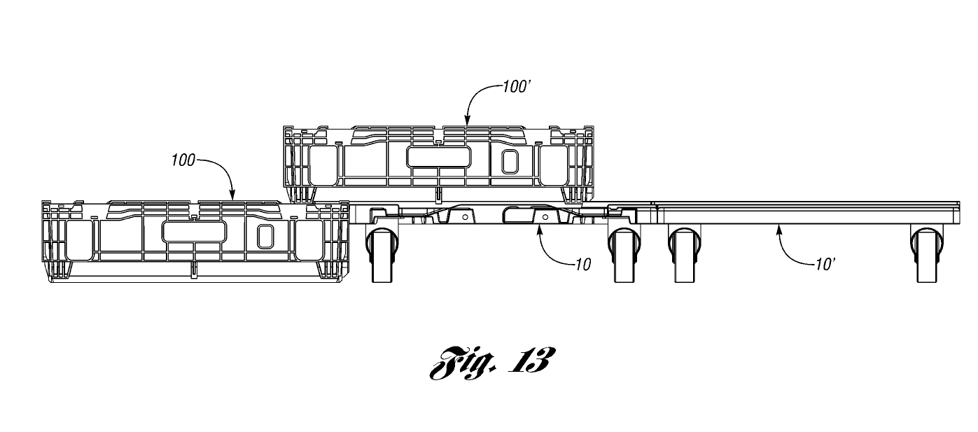

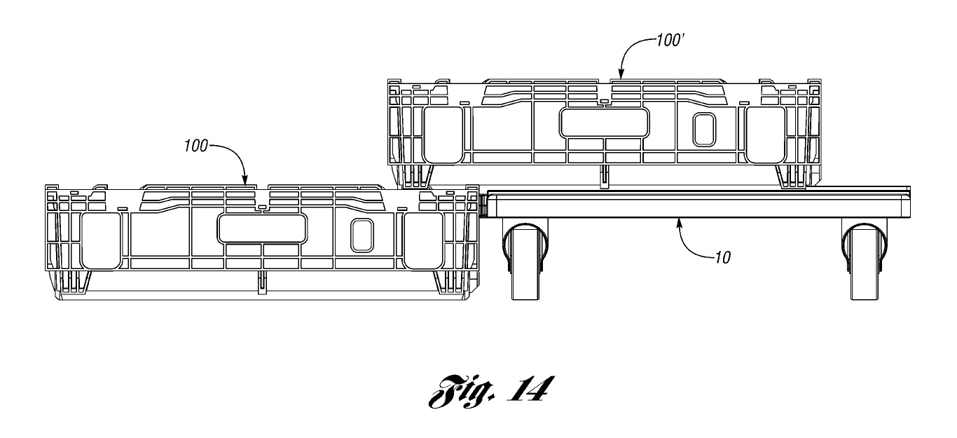

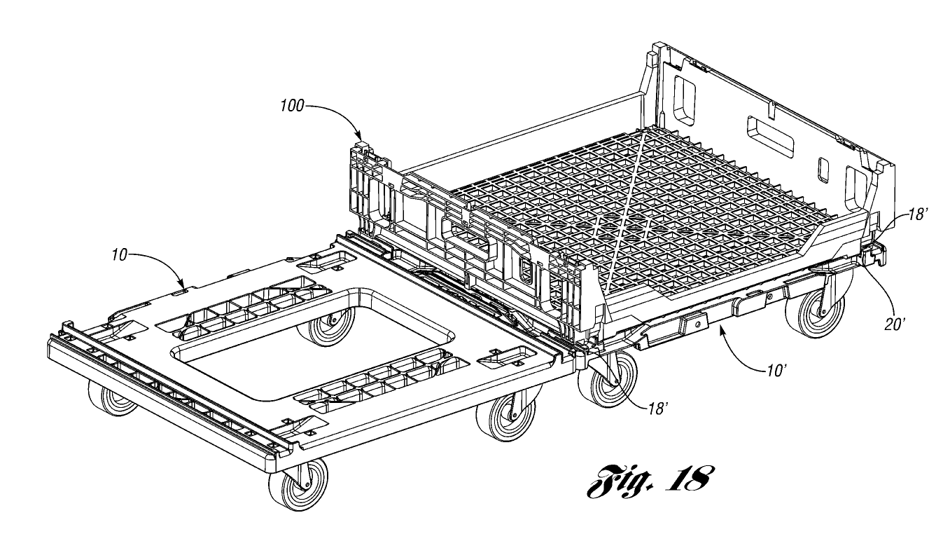

A dolly 10 according to one embodiment of the present invention is shown in FIGS. 1-20. Referring to FIG. 1, the dolly 10 includes a platform 12 supported by a plurality (in this case, four) of wheels 14 (swiveling or non-swiveling). The platform 12 includes a large central opening around which is defined a support surface. Guide rails 18 extend along front and rear edges of the platform 12. Rails stops 20 flange inwardly from opposite side edges of the guide rails 18 (in this embodiment, only three rails stops 20 are formed).

The platform 12 includes a connecting side edge 22, a connecting front edge 24, a non-connecting side edge 26 and a non-connecting rear edge 28. Alternatively, one or three or all four edges could be connecting.

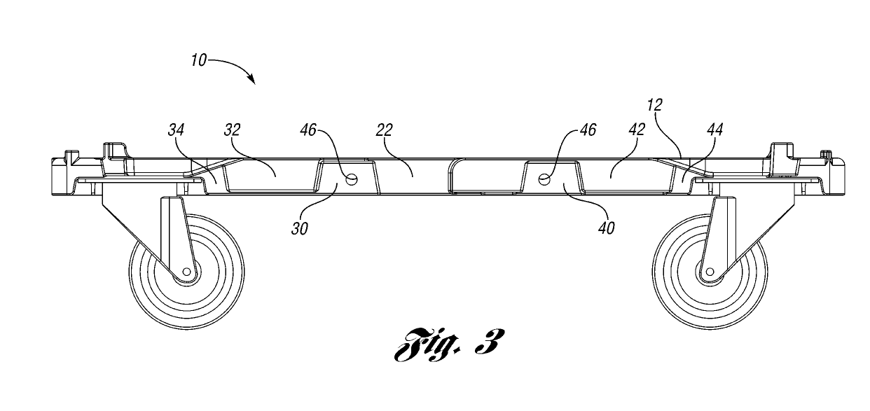

Referring to FIGS. 1 and 3, the connecting side edge 22 includes a plurality of alternating projections and recesses, which are complementary to one another about a midline. For example, in the embodiment shown, one half of the connecting side edge 22 includes a first projection 30, a second recess 32 and a third projection 34. These are complementary to a first recess 40, a second projection 42, and a third recess 44 (respectively) formed on the other half of the connecting side edge 22. The second recess 32 opens upwardly, while the first recess 40 and third recess 44 open downwardly. Optional apertures 46 are formed through the first projection 30 and the first recess 40 (for example) for optional more permanent connection with a bolt or other connector.

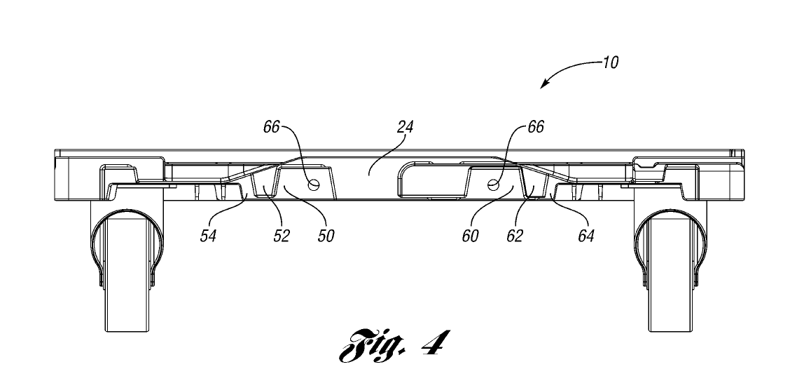

Similarly, referring to FIGS. 1 and 4, the connecting front edge 24 includes projections and recesses complementary about the midline. A first recess 60, a second projection 62 and a third recess 64 are formed on one half of the midline, while a complementary first projection 50, second recess 52 and third projection 54 are formed on the other side of the midline. Again, optional connecting apertures 66 are shown.

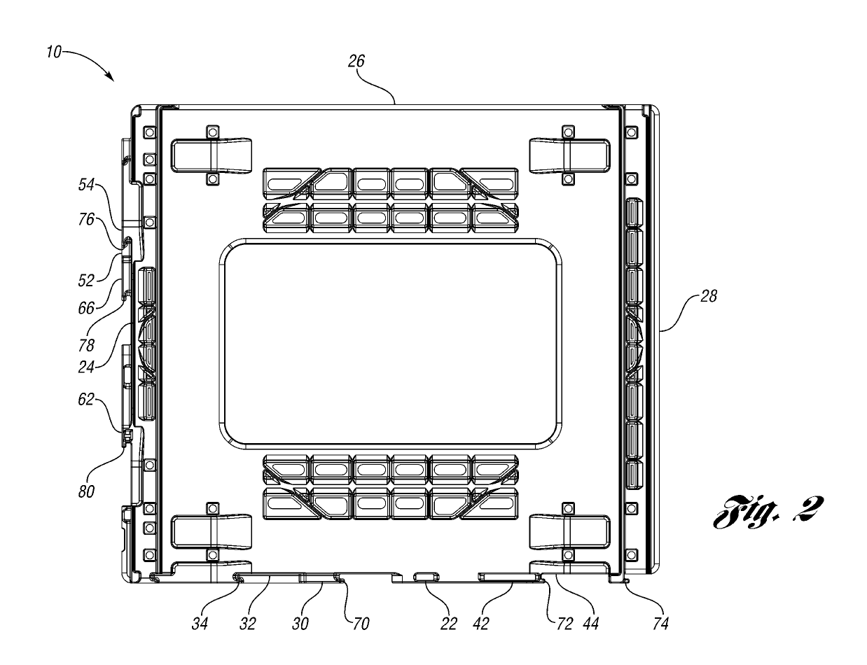

FIG. 2 is a top view of the dolly 10. As shown, the recesses and projections along the connecting side edge 22 and connecting front edge 24 have ribs 70, 72, 74, 76, 78, 80 (extending in a plane generally perpendicular to the plane of the platform 12) or other projections that assist in interlocking the recesses to the projections in the manner described below.

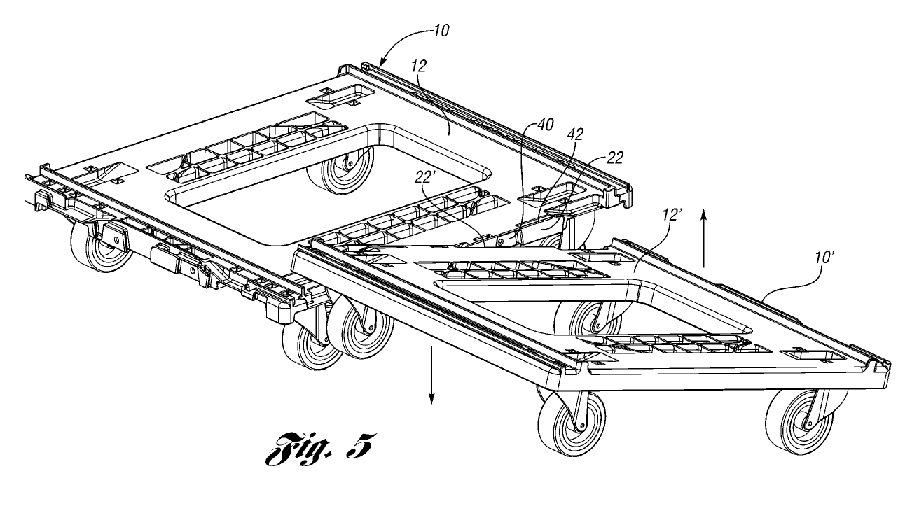

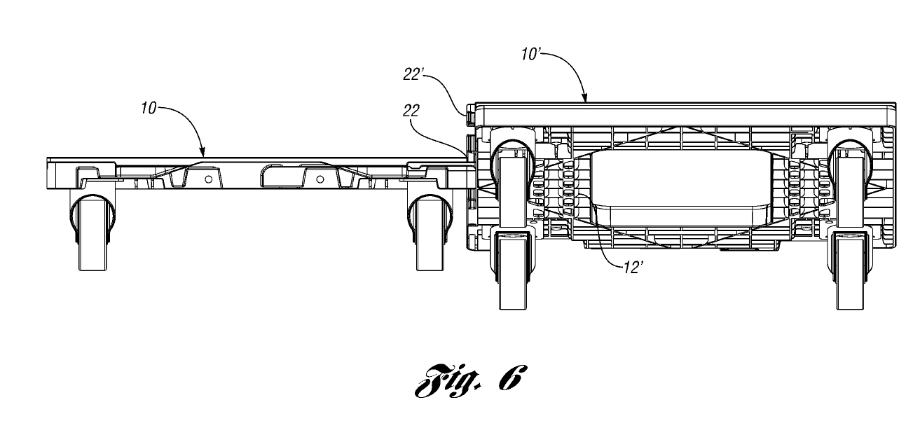

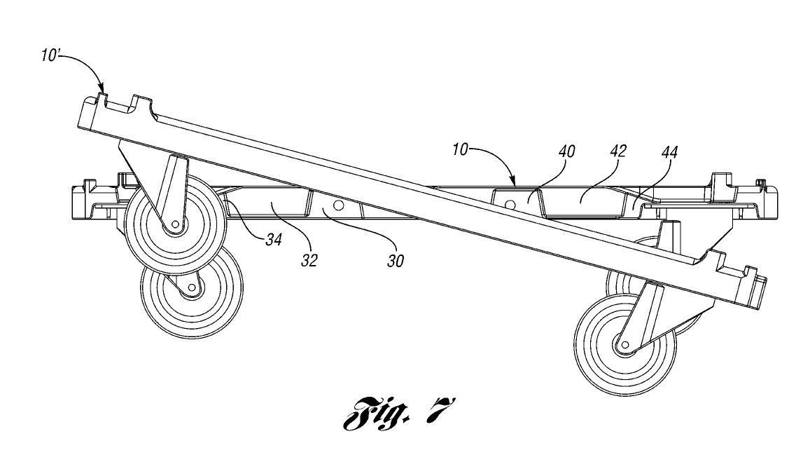

Referring to FIG. 5, the dolly 10 can be connected to an identical dolly 10′ in the following manner. First, the dolly 10′ is rotated 180° to align the connecting side edges 22, 22′. Once the connecting side edges 22, 22′ are facing one another, the dolly 10′ and the dolly 10 are rotated relative to one another (e.g. either or both of the dollies 10 can be rotated relative to ground) as shown in FIG. 5, i.e. rotating the first projection 30′, second recess 32′ and third projection 34′ of the dolly 10′ downward relative to the first recess 40, the second projection 42, and the third recess 44 of the dolly 10, and rotating the first recess 40′, the second projection 42′, and the third recess 44′ of the dolly 10′ upward relative to the first projection 30, second recess 32 and third projection 34 of the dolly 10. This relative rotation is about an axis parallel to the platform 12′. This is also shown in FIGS. 6 and 7.

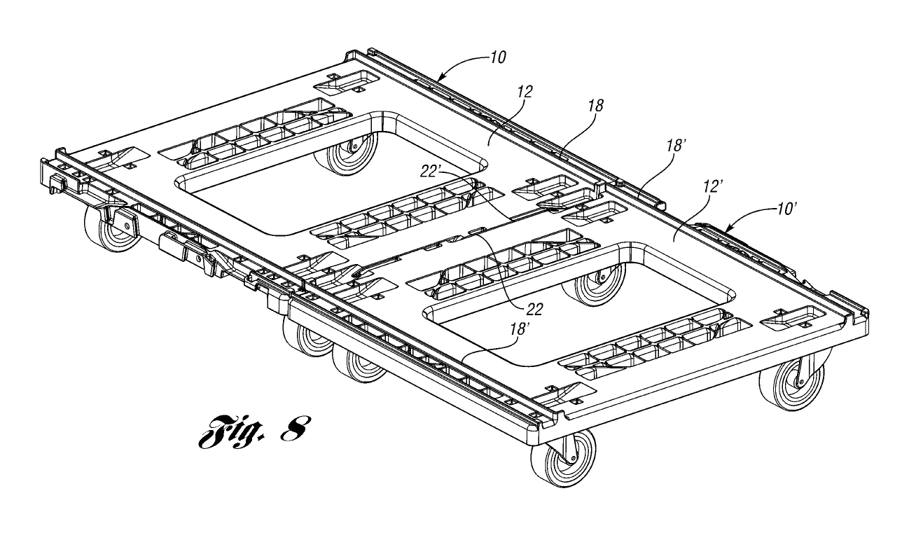

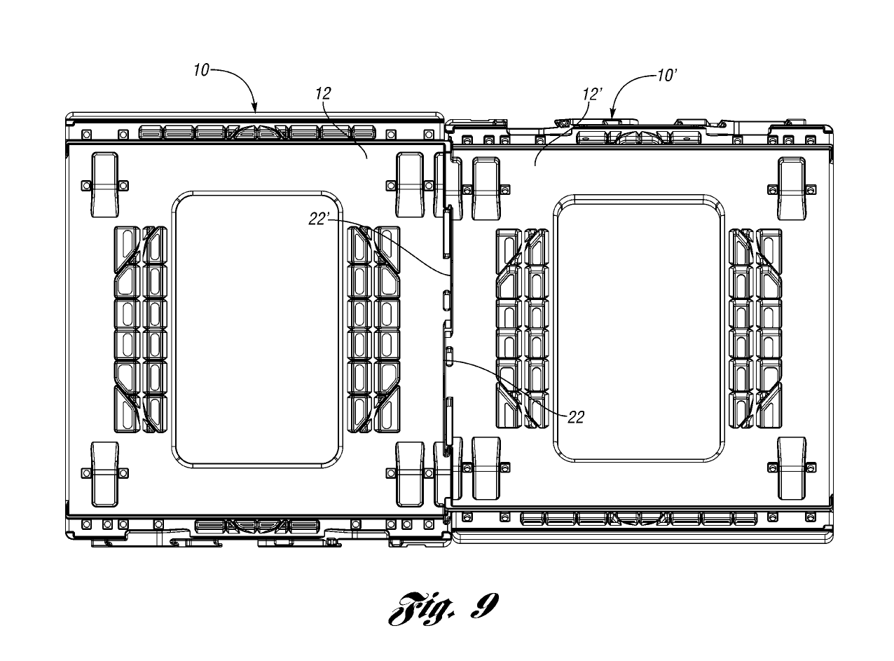

The dollies 10, 10′ are moved toward one another so that the connecting side edges 22, 22′ contact one another. The dollies 10, 10′ are then rotated relative to one another to a position where the platforms 12, 12′ are parallel to one another as shown in FIGS. 8 and 9. In this position, the first projection 30′, second recess 32′ and third projection 34′ of the dolly 10′ are interlocked with the first recess 40, the second projection 42, and the third recess 44 of the dolly 10. Similarly, the first recess 40′, the second projection 42′, and the third recess 44′ of the dolly 10′ are interlocked with the first projection 30, second recess 32 and third projection 34 of the dolly 10. Upon rotation, ribs or other projections upward in one or more of the first projection 30, 30′, second recess 32, 32′ and third projection 34, 34′ interlock with ribs or other projections downward in one or more of the first recess 40, 40′, the second projection 42, 42′, and the third recess 44, 44′.

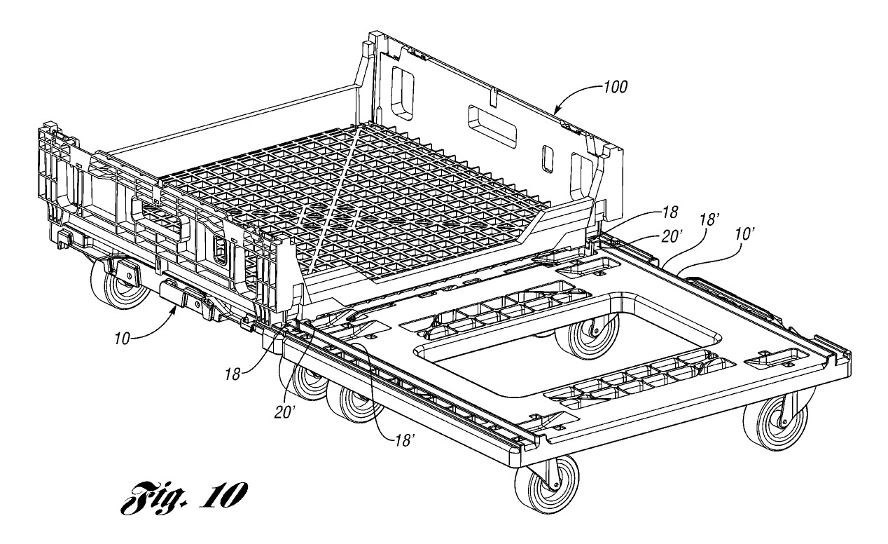

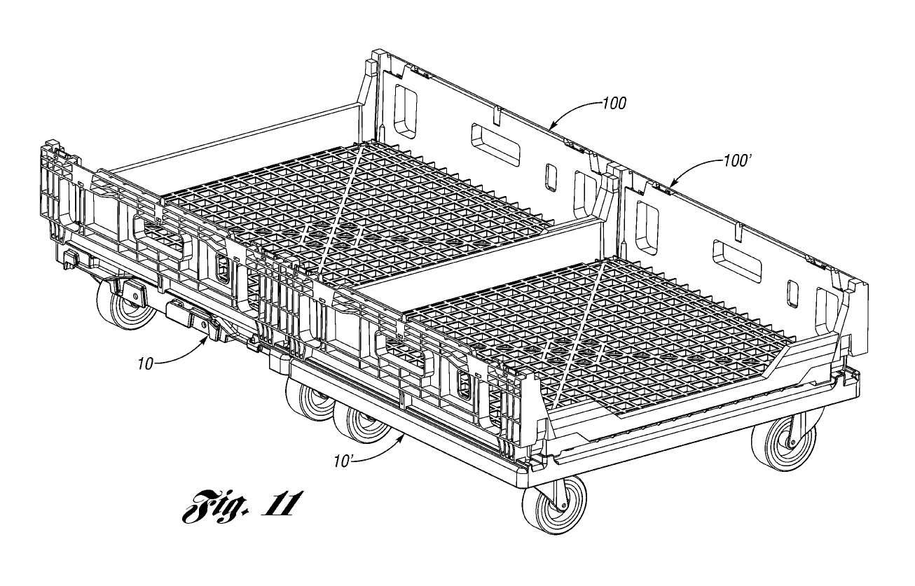

FIG. 10 shows the two connected dollies 10, 10′ of FIGS. 8 and 9 with a bakery tray 100 stacked on the dolly 10. The tray 100 rests on the platform 12 and is retained by the rails 18 and the rail stops 20. As shown in FIG. 11, another tray 100 can be stacked on the dolly 10′. In use, it is expected that each tray 100 would support a stack of trays 100, either loaded or empty.

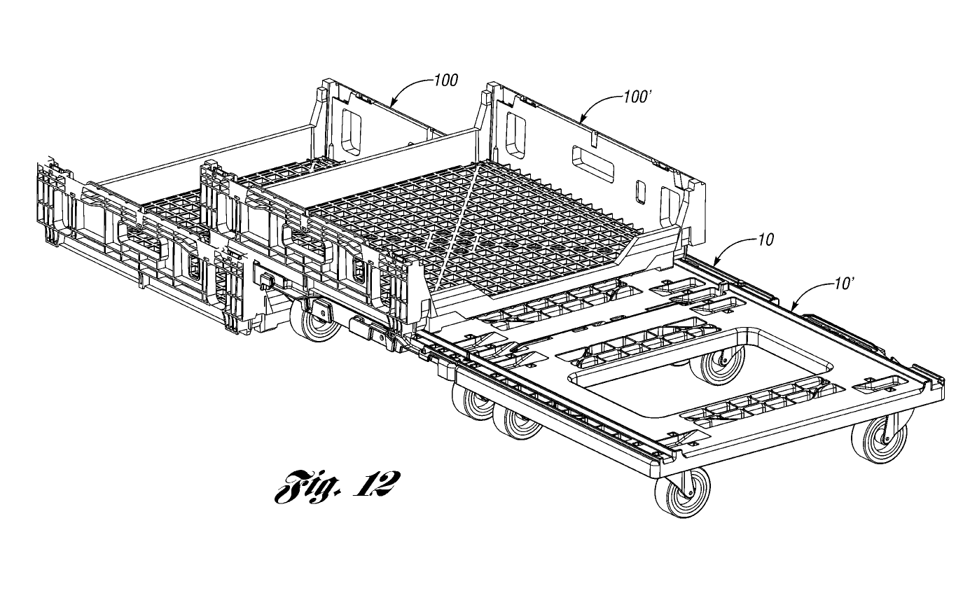

Referring to FIGS. 12, 13 and 14, the height of the platform 12 is configured such that an upper tray 100 stacked on a bottom tray 100 can be easily slid from the bottom tray 100 directly onto the dollies 10, 10′. Again, it is expected that the upper tray 100 would also have a stack of trays 100 stacked thereon, and the stack of trays 100 could be slid onto the dollies 10, 10′. The lower tray 100 can then be lifted onto the top of the stack of trays 100 on the dollies 10, 10′.

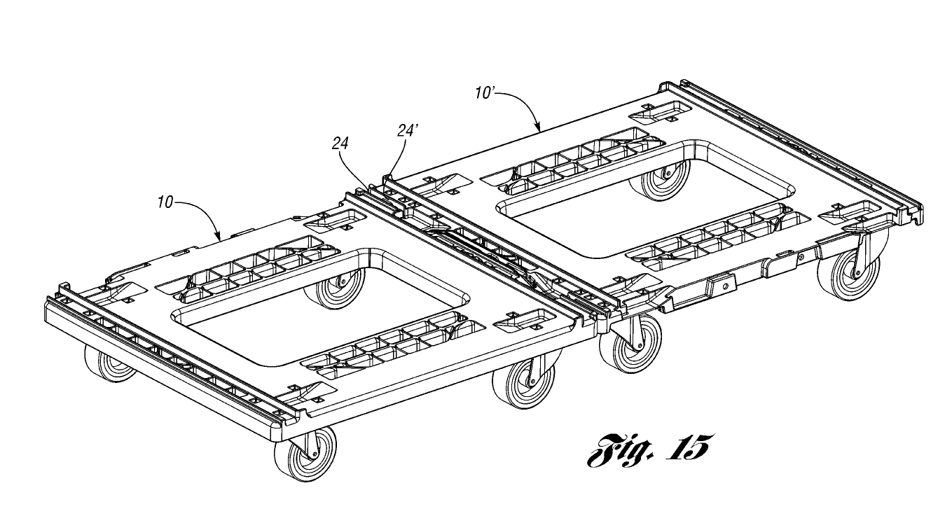

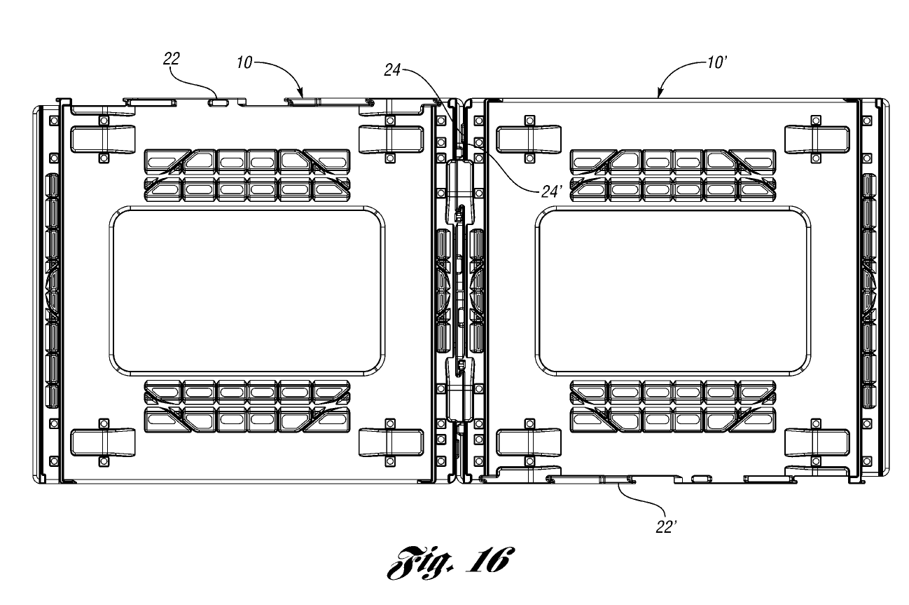

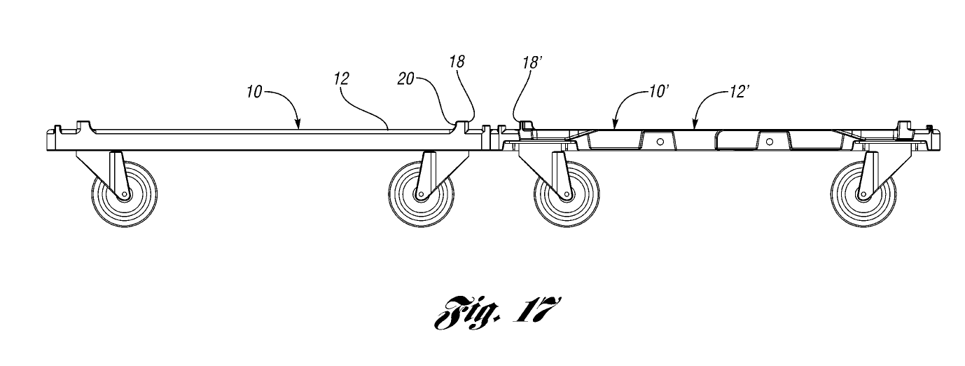

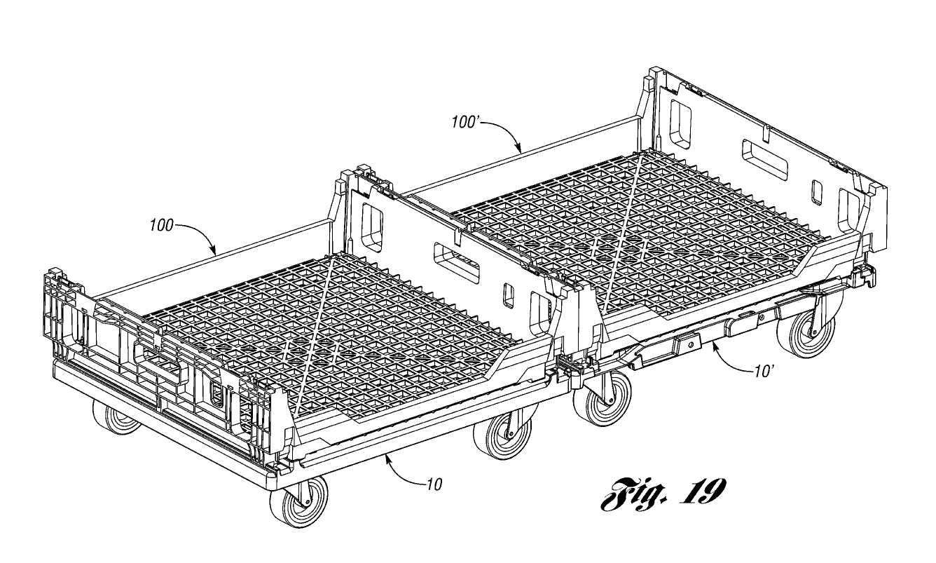

As shown in FIGS. 15 and 16, the connecting front edges 24, 24′ of the dollies 10, 10′ can also be connected to one another. The front edges 24, 24′ are connected in the same manner as the connecting side edges 22, 22′ as described above. As shown in FIG. 17, in this orientation, the rails 18, 18′ of the two dollies 10, 10′ are not longitudinally aligned, but are spaced laterally from one another. Therefore, the trays 100 when stacked on the dollies 10, 10′ are arranged with the side walls adjacent one another, as shown in FIG. 19.

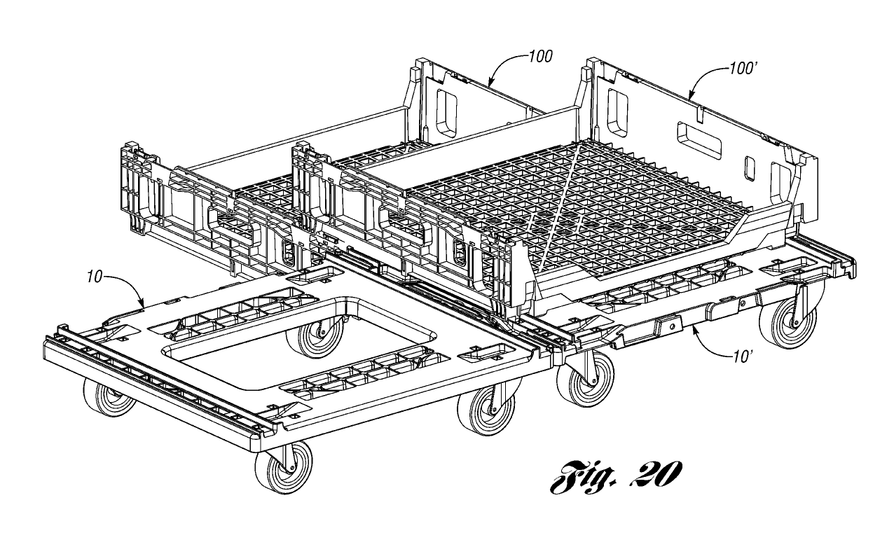

Referring to FIG. 20, in this orientation, the trays 100 above the bottom tray 100 in a stack of trays 100 can be slid easily from the bottom tray 100 onto the dollies 10, 10′.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A dolly comprising:
a platform for supporting items thereon, the platform including a first edge having a plurality of complementary projections and recesses, such that the platform can be selectively connected to a first edge of a platform of an identical dolly; and
a plurality of wheels supporting the platform.

2. The dolly of claim 1 wherein the platform can be selectively connected to the platform of the identical dolly without moving any connectors.

3. The dolly of claim 1 wherein the platform of the dolly can be selectively connected to the platform of the identical dolly by relative rotation of the platform of the dolly relative to the identical dolly.

4. The dolly of claim 3 in combination with the identical dolly, wherein the dolly is a first dolly and the identical dolly is a second dolly, wherein the platform of the first dolly is connected to the platform of the second dolly, such that the platforms of the first and second dollies are generally coplanar.

5. The dolly of claim 1 wherein the first edge is a side edge of the platform, the platform further including a front edge, perpendicular to the side edge, the front edge including a plurality of complementary projections and recesses, such that the front edge of the platform of the first dolly can be selectively connected to a front edge of the platform of the second dolly.

6. A method for connecting two dollies including the steps of:
a) moving a first platform of a first dolly toward a second platform of a second dolly;
b) rotating one of the first platform and the second platform relative to the other of the first platform and the second platform to a relative orientation in which the first platform is not parallel to the second platform; and
c) after step b), placing the first platform and the second platform in a relative parallel orientation, thereby connecting the first platform to the second platform.

7. The method of claim 6 wherein a plurality of protrusions on the first platform interlock with a plurality of recesses on the second platform during said step c).

8. The method of claim 6 further including the step of: d) after step c), causing relative rotation between the first platform and the second platform to disconnect the first platform from the second platform.

9. The method of claim 6 wherein said step b) includes rotating the one of the first platform and the second platform about an axis parallel to the one of the first platform and the second platform.
